(19) United States
(12) Patent Application Publication
(10) Pub. No.: US 2006/0133265 A1
(43) Pub. Date: Jun. 22, 2006

(54) Virtual private networking methods and systems

(75) Inventor: Cheng-Yin Lee, Ottawa (CA)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(73) Assignee: ALCATEL

(21) Appl. No.: 11/020,437

(22) Filed: Dec. 22, 2004

(51) Int. Cl. H04L 1/00

(52) U.S. Cl. 370/228

(57) ABSTRACT

Virtual private networking methods and systems are disclosed. A label switched path (LSP) is established between network elements which provide access to different autonomous systems (ASs). A record of resources which are used for the LSP is maintained, and a backup LSP is established between the network elements. The backup LSP excludes resources which were used for the LSP. Labeled routes associated with each AS are then redistributed to the network element within the other AS using the LSP or the backup LSP. In another embodiment, VPN labeled routes used by a first network element in a first AS and belonging to a VPN are aggregated into an aggregated inter-AS VPN labeled route, which is distributed to a second AS and redistributed to a second network element, in the second AS, which belongs to the VPN. A data structure for mapping VPN labeled routes to an aggregated inter-AS labeled route is also disclosed.

### FIELD OF THE INVENTION

This invention relates generally to Virtual Private Networks and, in particular, to providing VPN service across different Autonomous Systems in a communication system.

### BACKGROUND

An Autonomous System (AS) is generally regarded as a collection of routers, and possibly other communication equipment, which is managed under a single administrative authority. The equipment in an AS generally uses a common internal routing protocol for routing communication traffic.

Virtual Private Networks (VPNs) represent subsets of communication equipment or devices, typically referred to as “sites”, connected to a common communication system. Only sites which belong to the same subset or VPN may have connectivity to each other through the common communication system. Multiprotocol Label Switching (MPLS) and Border Gateway Protocol (BGP) represent examples of protocols which may be used to establish VPN services in a communication system.

VPNs may be relatively easily configured within a single AS. Although greater VPN service reach may be provided by allowing two or more sites of a VPN to be connected to different ASs which are connected in a communication system, VPN configuration is more difficult if sites belong to different ASs. Current techniques for establishing inter-AS communications, particularly VPN communications, tend to be relatively limited in terms of scalability. Resiliency of connections and therefore communication system availability are also of concern for conventional techniques.

Thus, there remains a need for methods and systems for providing scalable and resilient inter-AS VPNs.

### SUMMARY OF THE INVENTION

A method of providing a VPN including network elements which provide access to respective ASs, according to one aspect of the invention, includes establishing a label switched path (LSP) between the network elements, maintaining a record of resources which are used for the LSP in at least one of the ASs, establishing a backup LSP between the network elements, the backup LSP excluding the resources which are used for the LSP, and redistributing labeled routes associated with each AS to the network element within the other AS using the LSP or the backup LSP.

Another aspect of the invention relates to a system for providing a VPN including network elements which provide access to respective autonomous systems (ASs). The system includes a transceiver which is configured for communication within one of the ASs and a communication link connecting the ASs and a communications control module which is configured to establish an LSP between the network elements through the transceiver, to maintain a record of resources which are used for the LSP in at least one of the ASs, to establish a backup LSP between the network elements, the backup LSP excluding the resources which are used for the LSP, and to redistribute labeled routes associated with the one of the ASs to the network element within the other AS using the LSP or the backup LSP.

According to a further aspect of the invention, there is provided a method of configuring an inter-domain VPN between network elements which provide access to a plurality of ASs. The method includes distributing within a first AS a plurality of VPN labeled routes used by a first network element in the first AS and belonging to a VPN, aggregating at least a subset of the plurality of VPN labeled routes into an aggregated inter-AS VPN labeled route, distributing the aggregated inter-AS VPN labeled route to a second AS, and redistributing the aggregated inter-AS VPN labeled route to a second network element in the second AS belonging to the VPN.

A system for configuring an inter-domain VPN between network elements which provide access to a plurality of ASs is also provided, and includes a transceiver adapted for communication both within a first AS and with a second AS, and a communications control module. The communications control module is configured to receive through the transceiver from a first network element in the first AS and belonging to a VPN a plurality of VPN labeled routes used by the first network element, to aggregate at least a subset of the plurality of VPN labeled routes into an aggregated inter-AS VPN labeled route, and to distribute the aggregated inter-AS VPN labeled route through the transceiver to the second AS for redistribution by the second AS to a second network element in the second AS belonging to the VPN.

In accordance with yet another aspect of the invention, there is provided a data structure which includes data fields storing identifiers associated with respective VPN labeled routes which are used by a first network element in a first AS and belonging to a VPN and have been distributed within the first AS by the first network element. The data structure also includes a data field storing an identifier of an aggregated inter-AS VPN labeled route into which the plurality of VPN labeled routes is aggregated. As above, the aggregated inter-AS VPN labeled route is distributed to a second AS for redistribution to a second network element in the second AS belonging to the VPN.

Other aspects and features of embodiments of the present invention will become apparent to those ordinarily skilled in the art upon review of the following description of specific illustrative embodiments of the invention.

### BRIEF DESCRIPTION OF THE DRAWINGS

Examples of embodiments of the invention will now be described in greater detail with reference to the accompanying drawings, in which:

FIG. 1 is a block diagram of a communication system in which embodiments of the invention may be implemented;

FIG. 2 is a flow diagram of a method according to an embodiment of the invention;

FIG. 3 is a block diagram of an example communication network element or communication equipment in which a system according to an embodiment of the invention may be implemented; and

FIG. 4 is a flow diagram of a method in accordance with further embodiment of the invention.

### DETAILED DESCRIPTION OF PREFERRED EMBODIMENTS

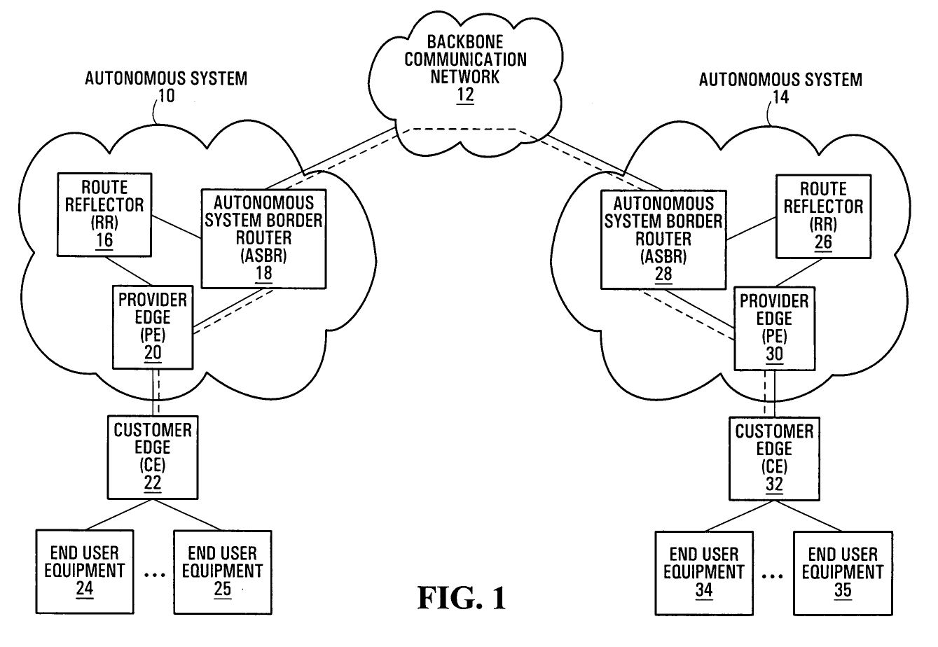

FIG. 1 is a block diagram of a communication system in which embodiments of the invention may be implemented. The communication system in FIG. 1 includes two ASs 10, 14 connected to the same common backbone communication network 12 through respective AS Border Routers (ASBRs) 18, 28. Service provider edge communication equipment associated with service providers, represented as Provider Edge (PE) blocks 20, 30 in the ASs 10, 14 provide access to the ASs and the backbone communication network 12 for customer edge (CE) equipment 22, 32, which are in turn connected to end user equipment 24, 25, 34, 35. Each AS 10, 14 also includes a Route Reflector (RR) 16, 26 for distributing routing information within the AS.

Although many ASs may be connected to the backbone communication network 12, only two have been shown in FIG. 1 for simplicity. The techniques described herein may be extended to communications between more than two ASs. In this case, the ASs may include ASs which are connected to different backbone communication networks. For example, the AS 14 might also be connected to a further backbone communication network to which another AS is connected. It may then be possible, in accordance with embodiments of the invention, to establish communications between the AS 10 and the other AS through the AS 14 and both backbone communication networks.

More generally, the invention may be implemented in communication systems having fewer, further, or different components with different interconnections than shown in FIG. 1. Not all types of communication network will employ RRs, for instance. Similarly, communication traffic within an AS or other type of network may be switched through intermediate network elements between a PE, which is typically a router, and an ASBR. Many different CE to end user equipment topologies are also possible.

In addition, the particular components shown in FIG. 1 are intended as illustrative examples of types of communication equipment in conjunction with which embodiments of the invention may be implemented. Although ASBRs, RRs, PEs, and CEs, for instance, are often associated with specific protocols or transfer mechanisms, the invention is not limited thereto.

Accordingly, it should be appreciated that the system of FIG. 1, as well as the contents of the other drawings, are intended solely for illustrative purposes, and that the present invention is in no way limited to the particular example embodiments explicitly shown in the drawings and described herein.

Those skilled in the art will be familiar with various types of communication network and equipment which may be implemented in the communication system of FIG. 1 and the normal operations associated with such a communication system. In general, end user equipment 24, 25 and 34, 35 is provided with access to the ASs 10, 12 through the CEs 22, 32 and the PEs 20, 30. The CEs 22, 32 represent communication equipment, illustratively routers, associated with an owner or operator of the end user equipment 24, 25 and 34, 35 such as a corporate owner of employee work stations, or other network elements like bridges, switches, etc. Communication equipment associated with a provider of communication services, an Internet Service Provider (ISP), for example, is similarly represented by the PEs 20, 30, which may also be routers.

Ingress communication traffic which is received from a CE 22, 32 is routed on connections within an AS 10, 14 by a PE 20, 30, and to an ASBR 18, 28 if the traffic is destined for an address or equipment outside the AS 10, 14. A PE 20, 30 also routes egress communication traffic which is destined for a CE 22, 32 or an end user device 24, 25 or 34, 35 connected thereto. Intermediate communication equipment or components may also be involved in routing traffic within each AS 10, 14. In some embodiments, edge or border routers, such as the PEs 20, 30 and the ASBRs 18, 28, support both intermediate routing functions and ingress/egress functions. Although the RRs 16, 18 might not be directly involved in actually switching or routing communication traffic, these functions may be dependent upon communication connections for which addresses or other information is distributed by the RRs 16, 26.

Communication traffic routing within or through the backbone communication network 12, which may be an Internet Protocol (IP) network for instance, may be accomplished in a substantially similar manner using border communication equipment and possibly intermediate communication equipment.

Communications between the ASs 10, 14 may involve one of two possible scenarios, with the ASs 10, 14 either trusting or not trusting each other. The first scenario may exist when the ASs are commonly owned or operated or belong to a trusted network of ASs, for instance. However, it will be appreciated that trust will not always have been established between different ASs 10, 14.

In either of these scenarios, the problem remains as to how scalable and resilient multiple-domain PE-based VPN service can be provided. With reference to FIG. 1, PE 20 in AS 10 will not be able to establish and maintain a secure VPN connection to PE 30 in AS 14 via conventional internal BGP, for example. Although internal BGP and other protocols are suitable for establishing VPNs in the case of a single AS, these protocols cannot simply be extended to multiple ASs.

The Internet Society Request for Comments document RFC-2547 by E. Rosen et al., entitled “BGP/MPLS VPNs”, and published in March 1999, suggests 3 ways to handle multiple-AS VPNs.

A first option proposed in RFC-2547 involves exchanging routing tables between ASs. For example, VPN Routing and Forwarding instances (VRFs) may be exchanged to establish VRF-to-VRF connections at the ASBRs 18, 28 in FIG. 1. Although this option may avoid misrouting of VPN routes by provisioning of VRFs on ASBRs, ASBR platform resources impact may be significant in that a VRF is required for each inter-AS VPN, and accordingly each ASBR may have to maintain a large number of routes. The number of routes to be maintained at the ASBRs also affects scalability.

Another option proposed in RFC-2547 involves redistribution of labeled VPN-IPv4 routes between ASBRs using external BGP. According to this scheme, a PE, illustratively the PE 20, advertises a labeled VPN-IPv4 prefix X to the ASBR 18 in the AS 10, using internal Multiprotocol BGP (MBGP) for instance. External MBGP is then used at the ASBR 18 for distributing the labeled VPN-IPv4 prefix X to the ASBR 28 in the AS 14. In this case, only a BGP4 label (tunnel label), not a Label Distribution Protocol (LDP) label (VPN label), is distributed. Although the ASBR 18 may participate in both control plane and data plane operations for a VPN, in the data plane, the ASBR 18 typically only switches labeled packets with labels which it had itself assigned.

Three inner Label Switched Path (LSP) segments are thereby established, at the same level, between the PE 20 and the PE 30. These LSP paths include paths between the PE 30 and the ASBR 28, the ASBR 28 and the ASBR 18, and the ASBR 18 and PE 20.

An outer LSP or tunnel is also set up between the PEs 20, 30. LDP may be used to set up PE-to-ASBR portions of the outer LSP. Direct peering between ASBRs may be an alternative to an LSP for the inter-ASBR portion of the outer LSP or tunnel.

In this label distribution option, the number of labels stored at an ASBR is dependent on the number of inner labels required for all VPNs that straddle across ASs. However, as an ASBR is involved in VPN routing and data plane operations in a label redistribution scheme, label redistribution may have a significant impact on ASBR platform resources.

One further option which is proposed in RFC-2547 is to use multihop external BGP redistribution of labeled VPN-IPv4 routes between PEs and labeled IPv4 between ASBRs. In this scheme, RRs or PEs advertise VPN-IPv4 information using multihop external MBGP between ASs. With reference to FIG. 1, the PEs 20, 30 learn routes or labels of each other from the ASBRs 18, 28. Although the ASBRs 18, 28 will not be able to filter BGP labels for non-existent VPN routes, each PE 20, 30, or RR if used, should filter non-existent VPN routes. The ASBR 18 may set the ASBR 28 as a next hop if it redistributes host routes of the AS 14 within its AS 10. Otherwise, the ASBR 18 may set next-hop-self if it does not redistribute host routes of the AS 14 within its AS 10.

After route or label distribution, one or more outer LSPs or tunnels are set up between PEs. If PE routes are made known to so-called P routers, which are intermediate routers in the ASs 10, 14, then one outer LSP label between the PEs 20, 30 is set up, for a total of 2 label stacks in the data plane, including an inner label for VRFs. If PE routes are only made known to the ASBRs 18, 28, then 2 outer label stacks are used, for a total of 3 label stacks in the data plane.

In terms of scalability, the number of labels which must be stored at each ASBR depends on the number of PEs, as internal routes of other ASs need to be injected into each AS. Accordingly, scalability and stability may be a problem.

Thus, the above options which are described in further detail in RFC-2547 generally neither scale well globally nor alone provide resilient VPN service. Embodiments of the invention provide for multiple-AS VPNs which are significantly more scalable and provide QoS and resiliency, allowing fast recovery, as compared to the options proposed in RFC-2547. For example, one embodiment of the invention provides mechanisms which support resilient VPN service. A further embodiment provides mechanisms to scale PE-based VPNs globally, illustratively by aggregating VPNID-IPv4 label states. Still another embodiment of the invention effectively combines these two embodiments to provide mechanisms to scale global VPN service by aggregating VPNID-IPv4 label states and to provide resilient global VPN service. These and other embodiments of the invention are described in further detail below.

According to one embodiment, if an Internet Protocol (IP) address or other address information for a remote PE to peer with in a VPN is known, an Inter-AS LSP may be used, from the PE 20 to the PE 30 in FIG. 1, for example. When LSP setup is initiated by the PE 20 for instance, loose source routing (ASBR 28, PE 30) is preferably used by the ASBR 18 and expanded by the ASBR 28 in the AS 14. The inter-AS LSP from PE 20 to PE 30 may thus be established by appending a loose source route (ASBR 28, PE 30) to an Explicit Route Object (ERO) within the AS 10 where Resource Reservation Protocol-Traffic Engineering (RSVP-TE) is employed for route setup. Leaking prefix routes or host routes used by PEs in an AS into other ASs with peering PEs in accordance with an aspect of the invention allows RSVP-TE signaling messages to be routed from the AS 10 to the AS 14.

In the above example of establishing a VPN including the PE 20 and the PE 30 using loose source routing in RSVP-TE, the ASBR 28 in the AS 14 expands the loose source route with internal routes, and relays the ERO in RSVP-TE to the next hop in the AS 14. RSVP-TE signaling subsequently progresses substantially as per existing specifications all the way to the PE 30.

If a diverse backup path is also to be set up, an ID of the LSP or a label and address of the ASBR 28 are recorded, in a Record Route Object (RRO) of the primary path setup signaling, for example. Recording of Shared Risk Link Groups (SRLGs) associated with the AS 14 may be less useful in establishing the diverse backup path, in that SRLGs used in different ASs may not be consistent. Thus, SRLGs used in the AS 14 might not be consistent with those used in the AS 10. Also, an owner or operator of an AS may not wish to reveal internal IP nodes and link addresses to another AS. When the backup path is subsequently being set up, the ASBR 28 preferably expands the recorded ID of the LSP or the recorded label and ASBR address into an internal SRLG or link/node exclusion. This approach overcomes problems in existing proposals which use SRLGs to exclude routes in different ASs.

Once an LSP has been set up between the PE 20 and the PE 30, labeled VPN-IPv4 routes are redistributed between PEs or RRs, using multihop external BGP for instance. Many labeled routes for the same VPN, or even different VPNs, may be tunnelled over a single inter-AS LSP.

The above embodiment involves leaking of internal routes between ASs and as such may be suitable for inter-AS VPNs where the ASs belong to the same service provider or where there is some trusts among ASs. A service provider, or multiple providers if ASs are owned by different providers, can thereby provide substantially the same features for VPNs spanning multiple ASs as for VPNs within an area of one AS.

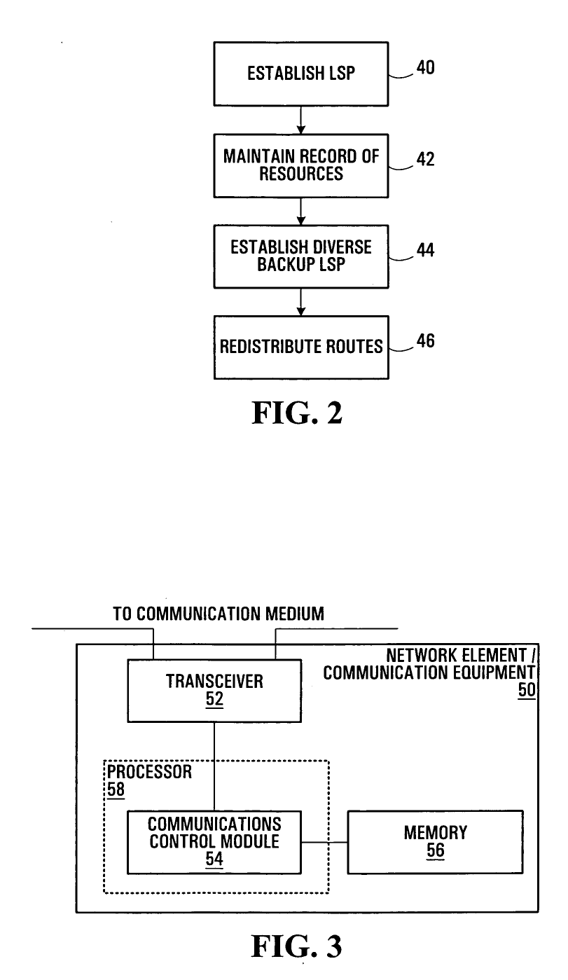

FIG. 2 is a flow diagram providing a somewhat broader illustration of a method of providing a VPN according to an embodiment of the invention described above. The method of FIG. 2 allows a VPN to be established between network elements, illustratively provider edge communication equipment, which provide access to respective ASs.

It should be appreciated that FIG. 2 is intended solely for illustrative purposes, and that embodiments of the invention may be implemented with fewer, further, or different operations, and/or operations which are performed in a different order than explicitly shown in FIG. 2.

The method of FIG. 2 begins at 40 with an operation of establishing an LSP between network elements to be included in a VPN. This operation may involve initiating LSP setup in one of the ASs and performing loose source routing in the other AS using RSVP-TE for instance, as described above.

At 42, a record of resources associated with the LSP in at least one of the ASs is maintained. Although shown as a separate operation in FIG. 2, the operation at 42 may be performed during LSP establishment at 40, by recording resource information in an RRO, for example.

A diverse backup LSP is then established at 44. The backup LSP excludes resources associated with the LSP to thereby improve resiliency and reliability of communications in a VPN. Resource information which specifies resources which have been used in the primary LSP established at 40 may be expanded or otherwise processed, if necessary, to determine appropriate resource exclusions during diverse backup path establishment at 44. Commonly owned U.S. patent application Ser. No. 10/369,567, filed on Feb. 21, 2003, published on Aug. 26, 2004 as Publication No. 2004/0165537, entitled “PROHIBIT OR AVOID ROUTE MECHANISM FOR PATH SETUP”, and incorporated in its entirety herein by reference provides examples of mechanisms which may be used for establishing a diverse backup path at 44, such as using an RSVP-TE Exclude Route Object (XRO).

Labeled routes associated with each AS are redistributed at 46, illustratively using BGP, to the network element within the other AS using the LSP or the backup LSP. Where multiple network elements in either or both of the ASs are part of the same VPN, then the operations shown in FIG. 2 may be repeated to establish VPN connections between all network elements within different ASs.

Embodiments of the invention have been described above primarily in terms of methods and method steps. FIG. 3 is a block diagram of an example communication network element or communication equipment in which a system according to an embodiment of the invention may be implemented.

In FIG. 3, only those components of the network element or communication equipment 50 which are directly involved in providing VPN functions as disclosed herein have been explicitly shown. A network element or communication equipment may include many more components which perform other functions.

The example network element or communication equipment 50 includes a transceiver 52 connected to a communications control module 54, which is also connected to a memory 56 and may be implemented as shown in a processor 58. The general structure shown in FIG. 3 is illustrative of an example structure of various AS components of FIG. 1, including PEs, RRs, and ASBRs. As will become apparent from the following description, the communications control module 54 may be configured differently at different components in a communication system. For example, a PE and an ASBR may be substantially similar in structure but perform different functions and thus may be configured differently.

The transceiver 52 may enable communication within an AS in the case of an RR, both within an AS and with customer equipment in the case of PE equipment, or both within an AS and with another AS in the case of AS border equipment such as an ASBR, for example. Those skilled in the art will be familiar with many different types of transceiver and the operation thereof, and the present invention is in no way limited to any specific type of the transceiver 52. The particular components, communication media, protocols, and operation of the transceiver 52 will be dependent upon the particular type of the network element or communication equipment 50. Given the detailed disclosure of embodiments of the invention in the present application, a person skilled in the art would be enabled to implement the invention using any of many different types of transceiver 52.

The communications control module 54 may be implemented as a hardware component such as an Application Specific Integrated Circuit (ASIC), in software stored in the memory 56 for execution by the processor 58, illustratively a microprocessor, or as some combination of both hardware and software. In processor-based embodiments, the processor 58 need not be a dedicated processor. The processor 58 may be a general purpose processor which is configured by executing software in the memory 56 to perform not only the functions of the communications control module 54, but also additional functions associated with other modules or operations of the network element or communication equipment 50.

Those skilled in the art will also be familiar with many memory devices which may be suitable for implementation as the memory 56, such as solid state memory devices or other types of memory device which are compatible with fixed, movable, or even removable storage media. Depending upon the information to be stored in the memory 56, volatile, non-volatile, or both types memory devices may be provided. In order to avoid loss of operating system, VPN, and other important software or information, non-volatile storage is generally preferred, although loading of such software into faster volatile memory for execution is also common. The memory 56 may also include multiple memory devices and/or types of memory device.

Considering ASBR operations as described in detail above, the communications control module 54 may be configured to establish an LSP between network elements in different ASs through the transceiver 52. The communications control module 54 also preferably maintains a record of resources which are associated with the LSP in the AS within which it operates, to establish a backup LSP between the network elements which excludes the resources associated with the LSP, and to redistribute labeled routes associated with its AS to the other AS using the LSP or the backup LSP. An ASBR may actively participate in establishing a diverse backup path, such as by expanding recorded resource information into internal exclusions as in the case of the ASBR 28 in the example described above, or initiate diverse backup path establishment at a different ASBR, which is substantially the role of the ASBR 18 in the above example.

The communications control module 54 may also perform additional operations, including those which have been described above with reference to methods of embodiments of the invention, and communication signal processing operations to route communication signals between network elements, for example.

As noted above, service provider equipment such as the PEs 20, 30 in FIG. 1 may also have the structure shown in FIG. 3. In such a network element, however, the transceiver 52 enables communications within an AS and with customer equipment. The communications control module 54 may also be configured somewhat differently, to perform such operations as initiating establishment of an LSP, distributing labeled routes for a VPN to an ASBR for redistribution in another AS, receiving from an ASBR labeled routes associated with network elements within another AS and belonging to a VPN to which the network element also belongs, and processing communication signals for routing to and from customer equipment.

In an RR, the transceiver 52 is adapted for communications within an AS, and the communications control module 54 is configured to receive routes from network elements such as PEs and/or border or gateway equipment such as ASBRs and to perform route distribution functions.

In a further embodiment of the invention, the number of states (VPN routing, labels) maintained in PEs, RRs, and ASBRs of an AS is reduced by an ASBR by aggregating intra-AS VPN labeled routes into fewer inter-AS VPN labeled routes. In FIG. 1, for example, the ASBR 18 may aggregate multiple VPN labeled routes which are used within the AS 10 into a single inter-AS VPN labeled route between the AS 10 and the AS 14. The ASBR 28 may similarly aggregate multiple labeled intra-AS routes within the AS 14 into a single inter-AS VPN labeled route.

Redistribution of aggregated labeled VPN routes between ASBRs may be accomplished using single or multihop external MBGP, for instance, as described in further detail below.

Consider again the example of establishing a VPN which includes the PEs 20, 30 of FIG. 1. The PE 20 distributes labeled VPN-IPv4 routes to the ASBR 18 in the AS 10. The ASBR 18 aggregates the intra-AS labeled VPN-IPv4 routes which are distributed by the PE 20 into one or more inter-AS labeled routes and distributes the aggregated labeled routes to the ASBR 28. The ASBR 28 redistributes these aggregated labeled routes, preferably changing the next-hop to self to avoid having to distribute its host routes to another AS, to member PEs of the same VPN, illustratively the PE 30, in the AS 14.

When the aggregated routes have been redistributed by the ASBR 28, the PE 30 knows to use an aggregated inner label to send to a particular VPN-IPv4 labeled route in the AS 10. The ASBR 28 forwards an aggregated label received from the PE 30 to the ASBR 18. The ASBR 18 pops the aggregated label and looks into the IPv4 destination address of a packet received from the ASBR 28. The ASBR 18 maps the packet to a corresponding labeled VPN-IPv4 route within the AS 10, and pushes the corresponding inner VPN-IPv4 label. The appropriate outer label to PE 20 is pushed onto the label stack next and the labeled packet is forwarded.

In some embodiments, the aggregated label is replaced with a corresponding inner VPN-IPv4 label. A VPN ID of the aggregated label is then matched to the IP destination address of the packet, and the outer label is pushed onto the label stack of the packet.

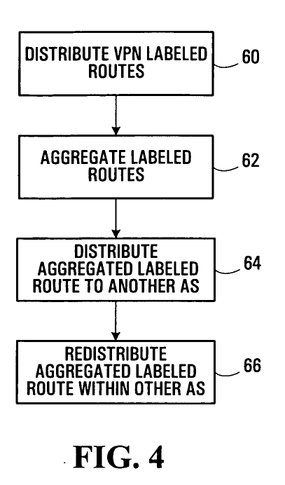

FIG. 4 is a flow diagram providing a more general illustration of method of configuring an inter-domain VPN between network elements associated with a plurality of ASs, which employs label aggregation according to an embodiment of the invention.

The method of FIG. 4 begins at 60 with an operation of distributing, within a first AS, VPN labeled routes used by a first network element in the first AS and belonging to a VPN. This operation may be performed by a PE, an RR, or some combination thereof. For example, a PE may distribute its labeled routes to an RR, which then distributes the routes within an AS.

At 62, the distributed VPN labeled routes, or at least a subset thereof, are aggregated into an aggregated inter-AS VPN labeled route. All of the distributed VPN labeled routes may be aggregated into a single aggregated inter-AS VPN labeled route, or subsets of the distributed VPN labeled routes may be aggregated into respective aggregated inter-AS labeled routes. It is also contemplated that some of the distributed VPN labeled routes may be aggregated whereas others are not aggregated.

Route aggregation at 62 effectively maps distributed VPN labeled routes to one or more aggregated inter-AS labeled routes. For example, identifiers of the distributed VPN labeled routes and the aggregated inter-AS labeled route or routes may be stored in a mapping table or other data structure in a memory, such as the memory 56 in FIG. 3. Further information, such as a destination IP address associated with the distributed VPN labeled routes., may also be stored and used to determine which one of the distributed VPN labeled routes is to be used to forward received communication signals, illustratively packets, which specify an aggregated inter-AS labeled route.

In one embodiment, routes are aggregated at an ASBR by storing at least the following states: VPN IDs/Aggregate, IP Prefix/Aggregate, and Next Hop address. Depending on the targeted applications, for instance a private network or a virtual network for a VoIP service, either the VPN ID/Aggregate or IP Prefix/Aggregate can be used as the primary key when searching for a matching aggregated route.

The method proceeds at 64 with an operation of distributing the aggregated inter-AS VPN labeled route to a second AS. The aggregated inter-AS VPN labeled route is then redistributed at 66 to a second network element in the second AS belonging to the same VPN as the network element by which the VPN labeled routes were distributed.

After the aggregated inter-AS labeled route has been redistributed at 66, received communication signals specifying the redistributed aggregated inter-AS labeled route are processed and forwarded using one of the distributed VPN labeled routes which were aggregated into the aggregated inter-AS labeled route. As described above, the appropriate VPN labeled route may be determined on the basis of a destination which is also specified in or otherwise determined from the communication signal.

Label aggregation and redistribution may be the most suitable option for inter-provider inter-AS VPNs where ASs belong to different service providers or in other scenarios where there is little trust among ASs and yet still a need for a scalable VPN solution. Network elements such as ASBRs in one AS do not have access to VPN-IPv4 routes of any other ASs, and there is no leaking of remote PE or host routes. Embodiments in which label aggregation is used may also be suitable if a remote PE to peer with is not known by a local PE.

It should be appreciated that the above label aggregation and redistribution operations may be performed for multiple PEs in either or both of the ASs 10, 14, and/or for multiple inter-AS VPNs. It should also be appreciated that label aggregation may be employed by either or both of the ASBRs 18, 28. Thus, multiple intra-AS labeled routes between the PE 30 and the ASBR 28 in the AS 14 may also or instead be aggregated into inter-AS labeled routes substantially as described above.

According to a further embodiment of the invention, RSVP-TE is used to set up an outer tunnel and diverse paths between PEs in different ASs. With reference again to FIG. 1, within the AS 10, the PE 20 sets up outer RSVP-TE tunnels to other PEs and ASBRs which may be discovered via internal MBGP (i.e., the next-hops) for instance.

RSVP-TE tunnels to another AS 14 may also be established. Where an IP address of the remote PE 30 is not known, and the goal is to reduce states in the network and avoid leaking host routes to other ASs, the ASBRs 18, 28 may instead exchange VPNIDs for VPNs, PE IDs of PEs which are members of the VPNs, and corresponding next-hop(s). For example, the ASBR 18 may distribute VPNIDs for VPNs which include PEs within the AS 10 and set itself as next-hop. The ASBR 28 in the AS 14 is then aware of the VPNIDs in the AS 10, and redistributes the same VPNIDs to PEs in the AS 14 which belong to corresponding VPNs, but setting next-hop as self. VPN membership of each PE in the AS 14 may be determined using BGP VPN automatic discovery, for instance.

The PE 30 can then set up an LSP to the remote PE 20 in the AS 10, specifying the loose source route {PE 30, ASBR 28, VPNID}. The LSP is set up using RSVP-TE and a new VPN type length value (TLV) for example, assuming that the ASBR 18 is reachable from the ASBR 28 directly or through multiple hops. The ASBR 28 forwards the RSVP-TE message to the ASBR 18, since it is the next hop for the VPNID specified in the loose source route.

Labeled routes, once established, may then be distributed within ASs using the intra-AS RSVP-TE tunnels, aggregated, redistributed using the inter-AS RSVP-TE tunnel and the intra-AS RSVP-TE tunnels, and used for communications between the PEs 20, 30 substantially as described above.

Label aggregation as described above enhances scalability for multiple domain PE-based VPNs, as the total number of labeled VPNID-IPv4 routes in a domain or AS is the total number of labeled VPNID-IPv4 routes in the domain plus the total number of aggregated labeled VPNID-IPv4 routes in other domains. In other embodiments which do not aggregate labeled routes, the total number of labeled VPN-IPv4 routes depends on the total number of PEs to be peered in all domains. Labeled route aggregation and redistribution also avoids leaking of internal routing or label information between ASs.

Label aggregation may be implemented at an ASBR or other communication equipment having the general structure shown in FIG. 3. For inter-domain VPN configuration functions, the communications control module 54 is preferably configured to receive from a first network element, in the first AS and belonging to a VPN, VPN labeled routes used by the first network element, to aggregate at least a subset of the VPN labeled routes into an aggregated inter-AS VPN labeled route, and to distribute the aggregated inter-AS VPN labeled route to the second AS for redistribution by the second AS to a second network element in the second AS belonging to the VPN.

The communications control module 54 may be further configured to receive an aggregated inter-AS VPN labeled route from another AS, and to redistribute the received aggregated inter-AS VPN labeled route to a network element in its own AS. Thus, an ASBR may aggregate internal routes into an aggregated inter-AS route and distribute the aggregated inter-AS route to one or more other ASs, receive aggregated inter-AS routes from other ASs and redistribute the aggregated inter-AS routes within its AS, or both.

Techniques for providing inter-domain VPNs have thus been described in detail above. These solutions may be offered, for example, in a router or edge network element, allowing carriers/ISPs to offer PE-based VPNs in a scalable and resilient manner across many ASs. The ASs may be owned by one operator (i.e., trusted networks) or different operators (i.e., untrusted networks).

What has been described is merely illustrative of the application of principles of the invention. Other arrangements and methods can be implemented by those skilled in the art without departing from the scope of the present invention.

For example, implementation of an embodiment of the invention for configuring inter-AS VPNs does not necessarily preclude the use of conventional techniques within an AS. Conventional techniques may be used to configure intra-AS VPNs or intra-AS portions of a VPN which includes both internal network elements and external network elements of another AS.

In addition, although described primarily in the context of methods and systems, other implementations of the invention are also contemplated, as instructions stored on a machine-readable medium for example.

Another variation which may be implemented in some embodiments of the invention is to apply rate-limiting at an ASBR to limit communication traffic flow from another AS. This type of control may be used, for example, to ensure that a previously agreed service level from another AS can be met.

A service level which can be supported on an aggregated route might also be determined at an ASBR and distributed or advertised to another ASBR. An AS may then automatically choose between two ASs, for instance, to forward communication traffic to one of two ASs or to forward duplicate communication traffic to both ASs depending on the service level provided by each AS. One advantage of such automatic selection is that the network administrator of an AS is then not required to provision or adjust routing metrics or other parameters to load balance or choose the AS to which traffic is to be forwarded. The service level for an aggregated route, announced by an AS, is assured by the AS. In addition or alternatively, an ASBR may measure a service level or obtain a service level measurement and load balance between domains accordingly.

Crankback is one technique which may be used when an aggregated route cannot provide resources or a service level required by a signalling message. The signalling message may effectively backtrack to any previous hop, and an attempt may then be made to send the signalling message via a different next hop. When a connection setup request is blocked because a node along a selected path cannot accept the request, for example, the path is “rolled back” to an intermediate node, which attempts to discover another path to the final destination.

Other techniques may also be used to improve VPN resiliency. For example, ASBRs may install multiple routing planes, such as a primary route and a backup route, to each VPN—IP destination. U.S. patent application Ser. No. 10/911,692, filed on Aug. 5, 2004, entitled “METHOD FOR FORWARDING TRAFFIC HAVING A PREDETERMINED CATEGORY OF TRANSMISSION SERVICE IN A CONNECTIONLESS COMMUNICATIONS NETWORK”, and incorporated in its entirety herein by reference, discloses one possible multiple routing plane mechanism. In the event of failure of a link to an ASBR, multiple routing planes allow VPN-IP traffic to be quickly routed to another ASBR.

Various aggregation options may also be used in different embodiments of the invention. For instance, two routes IPA-VPN1 and IPB-VPN2, having IP-VPNID labels which include globally unique IP addresses IPA and IPB and belonging to different VPNs, may be aggregated into an aggregated route IPC-VPN1+2, which has another IP-VPNID label which includes a different IP address, IPC. This would allow, for example, communication traffic from different Voice over IP (VoIP) providers in different residential networks to be aggregated into a global IP-VPNID labeled route for different VPNs.

We claim:

1. A method of providing a virtual private network (VPN) including network elements which provide access to respective autonomous systems (ASs), the method comprising:
establishing a label switched path (LSP) between the network elements;
maintaining a record of resources which are used for the LSP in at least one of the ASs;
establishing a backup LSP between the network elements, the backup LSP excluding the resources which are used for the LSP; and
redistributing labeled routes associated with each AS to the network element within the other AS using the LSP or the backup LSP.

2. The method of claim 1, wherein maintaining comprises recording (i) an ID of the LSP or (ii) a label associated with the LSP and an address of communication equipment in the at least one AS.

3. The method of claim 1, wherein maintaining comprises maintaining a Record Route Object (RRO) of Resource Reservation Protocol-Traffic Engineering (RSVP-TE) LSP setup signaling.

4. The method of claim 1, wherein establishing a backup LSP comprises expanding information in the record of resources into an internal resource exclusion in the at least one of the ASs.

5. The method of claim 1, wherein redistributing comprises redistributing the labeled routes using Border Gateway Protocol (BGP).

6. A system for providing a virtual private network (VPN) including network elements which provide access to respective autonomous systems (ASs), the system comprising:
a transceiver configured for communication within one of the ASs and a communication link connecting the ASs; and
a communications control module configured to establish a label switched path (LSP) between the network elements through the transceiver, to maintain a record of resources which are used for the LSP in at least one of the ASs, to establish a backup LSP between the network elements, the backup LSP excluding the resources which are used for the LSP, and to redistribute labeled routes associated with the one of the ASs to the network element within the other AS using the LSP or the backup LSP.

7. The system of claim 6, wherein the communications control module is further configured to receive from the network element in the one of the ASs prefix routes or host routes used by the network element, and to leak the prefix routes or host routes into the other AS.

8. The system of claim 6, wherein the communications control module is further configured to establish a backup LSP by expanding information in the record of resources into an internal resource exclusion in the one of the ASs.

9. An autonomous communication system comprising:
a border router comprising the system of claim 6; and
service provider edge communication equipment comprising one of the network elements.

10. A communication system comprising:
a plurality of autonomous communication systems as recited in claim 9; and
a backbone communication network connecting the plurality of autonomous communication systems.

11. A method of configuring an inter-domain virtual private network (VPN) between network elements which provide access to a plurality of autonomous systems (ASs), the method comprising:
distributing within a first AS a plurality of VPN labeled routes used by a first network element in the first AS and belonging to a VPN;
aggregating at least a subset of the plurality of VPN labeled routes into an aggregated inter-AS VPN labeled route;
distributing the aggregated inter-AS VPN labeled route to a second AS; and
redistributing the aggregated inter-AS VPN labeled route to a second network element in the second AS belonging to the VPN.

12. The method of claim 11, wherein aggregating comprises aggregating multiple subsets of the plurality of VPN labeled routes into respective aggregated inter-AS labeled routes.

13. The method of claim 11, further comprising:
receiving a communication signal specifying the aggregated inter-AS labeled route;
determining a destination of the communication signal; and
forwarding the communication signal using one of the subset of the plurality of VPN labeled routes which corresponds to the determined destination.

14. The method of claim 13, wherein forwarding comprises applying rate-limiting to the received communication signals specifying the aggregated inter-AS labeled route.

15. The method of claim 11, wherein the plurality of VPN labeled routes further comprises VPN labeled routes used by a plurality of network elements in the first AS.

16. A system for configuring an inter-domain virtual private network (VPN) between network elements which provide access to a plurality of autonomous systems (ASs), the system comprising:
a transceiver adapted for communication both within a first AS and with a second AS; and
a communications control module configured to receive through the transceiver from a first network element in the first AS and belonging to a VPN a plurality of VPN labeled routes used by the first network element, to aggregate at least a subset of the plurality of VPN labeled routes into an aggregated inter-AS VPN labeled route, and to distribute the aggregated inter-AS VPN labeled route through the transceiver to the second AS for redistribution by the second AS to a second network element in the second AS belonging to the VPN.

17. The system of claim 16, further comprising:
a memory,
wherein the communications control module is further configured to aggregate at least a subset of the plurality of VPN labeled routes into an aggregated inter-AS VPN labeled route by storing identifiers of the plurality of VPN labeled routes and the aggregated inter-AS labeled route in a mapping table in the memory.

18. The system of claim 16, wherein the communications control module is further configured to receive a communication signal specifying the aggregated inter-AS labeled route, to determine a destination of the communication signal, and to forward the communication signal using one of the subset of the plurality of VPN labeled routes which corresponds to the determined destination.

19. The system of claim 16, wherein the communications control module is further configured to receive through the transceiver a plurality of VPN labeled routes used in a plurality of VPNs.

20. A machine-readable medium storing a data structure comprising:
a plurality of data fields storing identifiers associated with respective virtual private network (VPN) labeled routes used by a first network element in a first autonomous system (AS) and belonging to a VPN, the VPN labeled routes being distributed within the first AS by the first network element; and
a data field storing an identifier of an aggregated inter-AS VPN labeled route into which the plurality of VPN labeled routes is aggregated, the aggregated inter-AS VPN labeled route being distributed to a second AS for redistribution to a second network element in the second AS belonging to the VPN.
